(19) United States
(12) Patent Application Publication
(10) Pub. No.: US 2022/0281552 A1
(43) Pub. Date: Sep. 8, 2022

(54) ELECTRIC BALANCE BIKE

(71) Applicant: HL CORP (SHENZHEN), Shenzhen (CN)

(72) Inventor: Xuesen LIAO, Shenzhen (CN)

(21) Appl. No.: 17/745,905

(22) Filed: May 17, 2022

Related U.S. Application Data
(63) Continuation of application No. PCT/CN2020/000287, filed on Nov. 23, 2020.

(30) Foreign Application Priority Data
Nov. 25, 2019 (CN) 201922167656.3

(51) Int. Cl. B62M 6/40; B62K 3/02; B62K 9/00; B62M 6/90; B62M 7/12; B62J 43/13; B62J 25/00

(52) U.S. Cl. CPC B62M 6/40; B62K 3/02; B62K 9/00; B62M 6/90; B62M 7/12; B62J 43/13; B62J 25/00

(57) ABSTRACT

An electric balance bike includes: a bike frame having a seat at an intermediate position thereof, a head tube at a front end thereof, and a rear fork at a rear end thereof; a front fork connected to a lower end of the head tube; a handlebar connected to an upper end of the head tube; a front wheel connected to the front fork; a rear wheel connected to the rear fork; an actuating assembly arranged between the bike frame and the rear wheel, the actuating assembly having an actuator located under an intermediate section of the bike frame, a driving member located at an axle of the rear wheel, and a driving belt that are wrapped around the actuator and the driving member; and a rechargeable lithium battery detachably connected to the actuator.

### CROSS REFERENCE TO RELATED APPLICATIONS

The present application is a continuation-application of International Application PCT/CN2020/000287, with an international filing date of Nov. 23, 2020, which claims foreign priority of Chinese Patent Application No. 201922167656.3, filed on Nov. 25, 2019 in the China National Intellectual Property Administration of China, the contents of all of which are hereby incorporated by reference.

### BACKGROUND

### 1. Technical Field

The present disclosure generally relates to electric bikes, and particularly to an electric balance bike.

### 2. Description of Related Art

Electric bicycles are a very common means of transportation. They not only allow people to travel conveniently, but also do not produce any waste gas such as carbon dioxide when moving, which has the effect of energy saving and environmental protection. Therefore, electric bicycles have gradually become the first choice for many people as a means of transportation.

As a vehicle with battery cells as power source, electric bicycles have roughly the same structure as ordinary bicycles. The only difference is that an electric bicycle has a battery unit and a motor electrically connected to the battery unit as driving power. The motor uses the power of the battery unit as a power source, and drives the wheels of the electric bicycle to rotate, thereby driving the electric bicycle to move.

Earlier, some electric bicycles were connected by a motor mounted on the frame and linked by a chain. At present, front or rear hub motors are mounted in the hubs of the front or rear wheels of some electric vehicles, or wheel-side motors are mounted at sides of wheel hubs. However, there are many defects in the configuration of these motors. First, the center of gravity of a bicycle body is concentrated at the front of the bicycle body or the rear of the bicycle body. The position of the center of gravity will reduce the balance of the bicycle body, thereby affecting riding stability. Second, since the front wheel hub motor is arranged on a front wheel and the rear wheel hub motor is arranged on a rear wheel, such a configuration will increase the difficulty of maintenance during the maintenance process of the front wheel or the rear wheel.

In order to solve the above-mentioned defects, one approach is to arrange the motor to the intermediate portion of the bicycle body, so that the center of gravity can shift from the front of the bicycle body or the rear of the bicycle body to the intermediate portion of the bicycle body. This motor may generally be referred to as a mid-mounted motor. The mid-mounted motor must have a low rotational speed and a high torque output to meet the riding requirements of the bicycle body. Therefore, in order to obtain the power output of low speed and high torque, the mid-mounted motor needs to be additionally equipped with a planetary reducer with a low reduction ratio, to achieve the power output of low speed and high torque.

However, due to the low reduction ratio of the planetary reducer, the rotational speed of the mid-mounted motor cannot be greatly reduced and the torque of the mid-mounted motor cannot be greatly increased. Therefore, in order to achieve the power output of low speed and high torque, a motor with a medium-low speed and a medium-high torque needs to be used to meet the output requirements of low speed and high torque required for riding. However, compared with a high-speed and low-torque motor, the medium-low speed and medium-high torque motor has disadvantages such as large volume, heavy weight and high cost. Although the mid-mounted motor is large and heavy, it can still be applied in ordinary bicycles. If it is to be applied in a training bicycle (e.g., balance bike) for young children to train muscular endurance and balance, since these training bicycles are small in size, if a conventional mid-mounted motor is used, the size and weight of the motor are relatively large, which cannot meet the convenience and safety required for the training of muscular endurance and balance.

Additionally, most of the conventional electric bicycles use lead-acid batteries as the power source to power the motors. However, lead-acid batteries are large and heavy (about 16-30 kg) and cannot meet the short-range/short-time riding requirements such as convenience and safety, and need to be further improved.

Therefore, there is a need to provide an electric balance bike to overcome above-mentioned problems.

### SUMMARY

One aspect of the present disclosure is to provide an electric balancing bike that uses a detachable rechargeable lithium battery to provide a power source to drive the bike to move, which can overcome the shortcomings as mentioned above in the conventional electric bikes.

In order to solve the above-mentioned technical problems, the following technical solution is provided: An electric balance bike includes: a bike frame having a seat at an intermediate position thereof, a head tube at a front end thereof, and a rear fork at a rear end thereof; a front fork connected to a lower end of the head tube; a handlebar connected to an upper end of the head tube; a front wheel connected to the front fork; a rear wheel connected to the rear fork; an actuating assembly arranged between the bike frame and the rear wheel, the actuating assembly having an actuator located under an intermediate section of the bike frame, a driving member located at an axle of the rear wheel, and a driving belt that are wrapped around the actuator and the driving member; and a rechargeable lithium battery detachably connected to the actuator.

In one embodiment, the rechargeable lithium battery is a rechargeable lithium battery for hand tools.

In one embodiment, the electric balance bike further includes a casing arranged under the intermediate section of the bike frame, and a controller electrically coupled to the actuator. The actuator is arranged within a rear portion of the casing, the controller is arranged within a front portion of the casing, and the controller comprises at least one first connector external of the front portion of the casing.

In one embodiment, at least one first engaging portion is arranged at an outer surface of the front portion of the casing. The rechargeable lithium battery includes at least one second connector and at least one second engaging portion. The at least one second engaging portion is slidably engaged with the at least one first engaging portion, and the at least one second connector is to contact the at least one first connector.

In one embodiment, the electric balance bike further includes a toothed disc connected to a shaft of the actuator. The actuator is laterally arranged below the intermediate section of the bike frame, and the driving belt is wrapped around the driving member and the toothed disc.

In one embodiment, a seat tube is arranged through the middle section of the bike frame. The seat is arranged at an upper end of the seat tube, and a footrest is connected to a lower end of the seat tube.

In one embodiment, the handlebar includes a start control component and a brake control component that are electrically coupled to the controller and configured for control of the actuator.

In one embodiment, the actuator is a brushless motor.

The technical effects provided by the present disclosure are as follows: with the aforementioned configuration, the electric balancing bike of the present disclosure uses the rechargeable lithium battery for hand tools and the brushless motor as the power parts, which is small in size and light in weight, and is suitable for short-range/short-time riding by children. The electric balancing bike uses the rechargeable lithium battery to provide the power source and actuate the actuator to drive the driving belt to drive the electric balancing bike to move. Different from conventional balancing bikes, the present disclosure provides a racing entertainment effect. The use of the rechargeable lithium battery in the present disclosure has the advantages of relatively small size, ease of riding, ease of carry and replacement, and environmental protection performance.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic isometric view of an electric balance bike according to one embodiment.

FIG. 2 is a partial planar view of the electric balance bike.

FIG. 3 is an enlarged view of a portion of the electric balance bike.

FIG. 4 is an enlarged exploded view of a portion of the electric balance bike.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

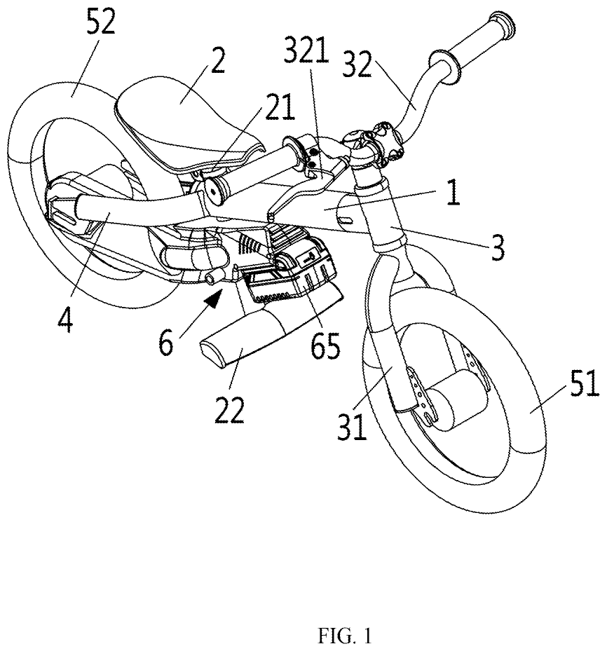

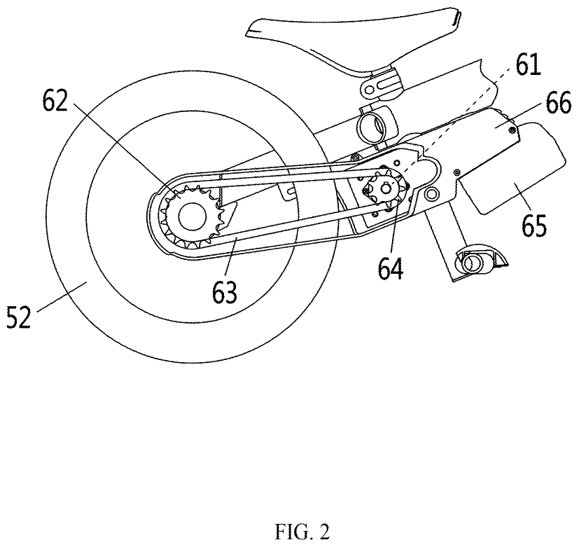

Referring to FIGS. 1 and 2, in one embodiment, an electric balance bike may include a bike frame 1 including a seat 2 at its intermediate position, a head tube 3 at its front end, and a rear fork 4 at its rear end. A front fork 31 is connected to a lower end of the head tube 3, and a handlebar 32 is connected to an upper end of the head tube 3. The handlebar 32 is to control rotation of the front fork 31. A front wheel 51 is connected to the front fork 31, and a rear wheel 52 is connected to the rear fork 4.

In one embodiment, the electric balance bike may further include an actuating assembly 6 arranged between the bike frame 1 and the rear wheel 52. The actuating assembly 6 may include an actuator 61 located under an intermediate section of the bike frame 1, a driving member 62 located at an axle of the rear wheel 52, and a driving belt 63 that are wrapped around the actuator 61 and the driving member 62. In one embodiment, a toothed disc 64 is connected to a shaft of the actuator 61. The actuator is laterally arranged below the intermediate section of the bike frame 1, and the driving belt 63 is wrapped around the driving member 62 and the toothed disc 64. In one embodiment, the driving member 62 can also be in the form of a toothed disc. A rechargeable lithium battery 65 is detachably connected to the actuator 61.

In one embodiment, the rechargeable lithium battery 65 can be a rechargeable lithium battery for hand tools, and the actuator 61 can be a brushless motor or other actuators that can provide rotating power, such as a brush motor. The rechargeable lithium battery used for hand tools in this embodiment is not only small in size and light in weight, but also only needs to be connected by slidable plugging, which increases the convenience of use. Compared with lead-acid batteries, the use of the rechargeable lithium batterie has the following advantages:

1. Small size: The weight of a lead-acid battery is typically 16-30 kg, and the size is large. A lithium battery is typically 2.5-3 kg and relatively small in size. As a result, it is easy to carry and replace, and is more suitable for use in the bike for short-range/short-time riding in this embodiment.

2. High durability: Lead-acid batteries generally have a deep charge and deep discharge of less than 300 cycles, and their lifespan is about two years. There is liquid in the lead-acid batteries. After a period of consumption, if it is found that the batteries are hot or the charging time is shortened, liquid needs to be added into the batteries. Lithium batteries have strong durability, slow consumption, and can be charged and discharged more than 500 cycles, with a typical lifespan of 4-5 years.

3. Environmentally friendly: Lead-acid batteries will cause pollution during the production process, and may also cause pollution if they are not recycled properly. Lithium batteries are relatively environmentally friendly.

The use of a brushless motor may offer several advantages as described below.

1. High efficiency: Higher performance than ordinary motors (high efficiency, high torque, high stability). 2. Small size: Space saving, low electromagnetic interference, and maintenance-free carbon brush. 3. The rotor size is much smaller than traditional induction motors and brushed motors, thereby providing better control performance. 4. Built-in motor driver that operates at a DC voltage of 18V.

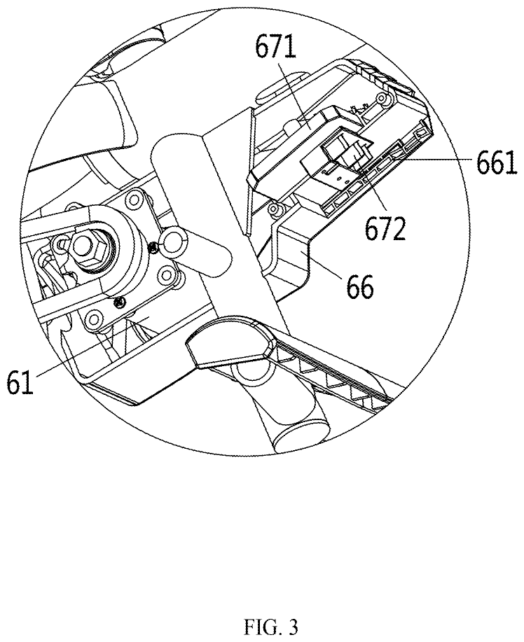

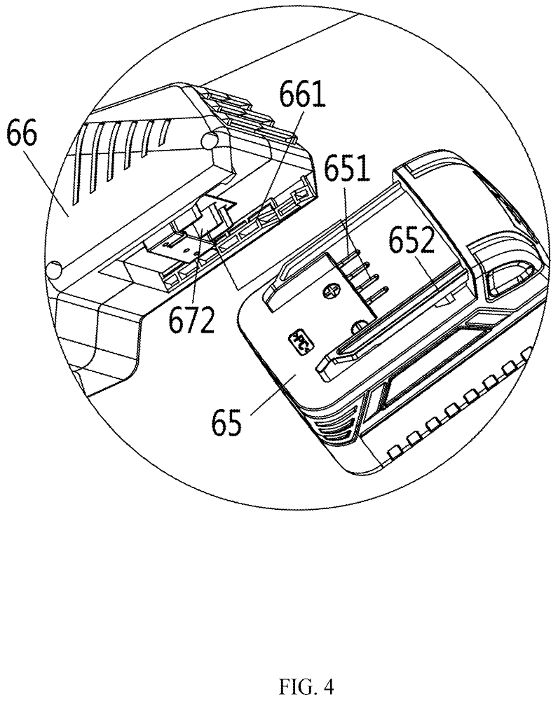

Referring to FIGS. 3 and 4, in one embodiment, the electric balance bike may further include a casing 66 arranged under the intermediate section of the bike frame 1, and a controller 671 electrically coupled to the actuator 61. The actuator 61 is arranged within a rear portion of the casing 66, and the controller 671 is arranged within a front portion of the casing 66. The controller 671 may include at least one first connector 672 external of the front portion of the casing 66. At least one first engaging portion 661 is arranged at an outer surface of the front portion of the casing 66. The rechargeable lithium battery 65 may include at least one second connector 651 and at least one second engaging portion 652. The at least one second engaging portion 652 is slidably engaged with the at least one first engaging portion 66, and the at least one second connector 651 is to contact the at least one first connector 672, which enables the actuator 61 and the rechargeable lithium battery 65 to be connected to each other. When the rechargeable lithium battery 65 is to be removed for charging, it is only needs to remove the rechargeable lithium battery 65 from the casing 66 through the first and second engaging portions 661 and 652 through an unplugging action. The forgoing first and second connectors 672 and 651 may be conductive sheet structures, and the first and second engaging portions 661 and 652 may be in the form of guide rails that can refer to the structure form of the conventional rechargeable lithium batteries for hand tools.

In one embodiment, a seat tube 21 is arranged through the middle section of the bike frame 1. The seat 2 is arranged at an upper end of the seat tube 21, and a footrest 22 is connected to a lower end of the seat tube 21. The footrest 22 is located below the casing 66 and can be stepped on by the feet of a user. In on embodiment, the handlebar 32 may include a start control component and a brake control component 321 that are electrically coupled to the controller 671 and configured for control start/stop of the actuator 61.

The embodiments above are only illustrative for the technical solutions of the present disclosure, rather than limiting the present disclosure. Although the present disclosure is described in detail with reference to the above embodiments, those of ordinary skill in the art should understand that they still can modify the technical solutions described in the foregoing various embodiments, or make equivalent substitutions on partial technical features; however, these modifications or substitutions do not make the nature of the corresponding technical solution depart from the spirit and scope of technical solutions of various embodiments of the present disclosure, and all should be included within the protection scope of the present disclosure.

What is claimed is:

1. An electric balance bike comprising:
a bike frame comprising a seat at an intermediate position thereof, a head tube at a front end thereof, and a rear fork at a rear end thereof;
a front fork connected to a lower end of the head tube;
a handlebar connected to an upper end of the head tube, the handlebar configured to control rotation of the front fork;
a front wheel connected to the front fork;
a rear wheel connected to the rear fork;
an actuating assembly arranged between the bike frame and the rear wheel, the actuating assembly comprising an actuator located under an intermediate section of the bike frame, a driving member located at an axle of the rear wheel, and a driving belt that are wrapped around the actuator and the driving member; and
a rechargeable lithium battery detachably connected to the actuator.

2. The electric balance bike of claim 1, wherein the rechargeable lithium battery is a rechargeable lithium battery for hand tools.

3. The electric balance bike of claim 1, further comprising a casing arranged under the intermediate section of the bike frame, and a controller electrically coupled to the actuator, wherein the actuator is arranged within a rear portion of the casing, the controller is arranged within a front portion of the casing, and the controller comprises at least one first connector external of the front portion of the casing.

4. The electric balance bike of claim 3, wherein at least one first engaging portion is arranged at an outer surface of the front portion of the casing, the rechargeable lithium battery comprises at least one second connector and at least one second engaging portion, the at least one second engaging portion is slidably engaged with the at least one first engaging portion, and the at least one second connector is configured to contact the at least one first connector.

5. The electric balance bike of claim 4, further comprising a toothed disc connected to a shaft of the actuator, wherein the actuator is laterally arranged below the intermediate section of the bike frame, and the driving belt is wrapped around the driving member and the toothed disc.

6. The electric balance bike of claim 4, wherein a seat tube is arranged through the middle section of the bike frame, the seat is arranged at an upper end of the seat tube, and a footrest is connected to a lower end of the seat tube.

7. The electric balance bike of claim 4, wherein the handlebar comprises a start control component and a brake control component that are electrically coupled to the controller and configured for control of the actuator.

8. The electric balance bike of claim 4, wherein the actuator is a brushless motor.
